(19) United States
(12) Patent Application Publication
(10) Pub. No.: US 2011/0057888 A1
(43) Pub. Date: Mar. 10, 2011

(54) TOUCH SCREEN DEVICE

(76) Inventors: Jae Kyung KIM, Gyunggi-do (KR); Yeon Ho SON, Gyunggi-do (KR); Dong Sun PARK, Seoul (KR)

(21) Appl. No.: 12/630,374

(22) Filed: Dec. 3, 2009

(30) Foreign Application Priority Data
Sep. 9, 2009 (KR) 10-2009-0085058

(51) Int. Cl. G06F 3/041

(52) U.S. Cl. 345/173; 340/407.1

(57) ABSTRACT

Disclosed herein is a touch screen device. In the touch screen device, a touch screen panel receives an external input signal. An image display is provided under the touch screen panel to convert an electric signal into an image signal. A rigid body which vibrates is provided under the image display. A first connector connects the image display to the rigid body. A vibration unit is mounted to the rigid body to generate vibrations. A weight is mounted to the rigid body to increase the mass of the rigid body. An elastic member is mounted to the rigid body to increase the vibrational displacement of the rigid body. A lower support is provided under the rigid body. A second connector connects the rigid body to the lower support. A third connector connects the touch screen panel to the lower support.

### CROSS REFERENCE TO RELATED APPLICATION

This application claims the benefit of Korean Patent Application No. 10-2009-0085058, filed Sep. 9, 2009, entitled “Touch Screen Device”, which is hereby incorporated by reference in its entirety into this application.

### BACKGROUND OF THE INVENTION

1. Technical Field

The present invention relates to a touch screen device.

2. Description of the Related Art

Recently, according to requirements of consumers to enhance the convenience of using electronic products, there are an increasing number of electronic products using touch screens which allow a signal to be input in a manner wherein the presence and location of touching within a display area is detected. Touch screen devices not only include the concept of inputting a signal by touching but also include the concept of incorporating the intuitive experience of a user into an interface and of diversifying feedback.

Touch screen devices have many advantages because the size of a device can be reduced, it can be easily and simply manipulated, the specifications thereof can be easily changed, a user can easily recognize information, and it is compatible with other IT devices. Because of these advantages, touch screen devices are widely used in various fields including industry, traffic, services, medical care, mobile products, etc.

As shown in FIG. 8, in a touch screen device 10 according to a conventional technique, a touch screen panel 11, an image display 12, a circuit board and a support casing 14 are coupled to each other by double-sided adhesive tape 13.

However, the double-sided adhesive tape 13 which couples the elements to each other interferes with the vibrating operation of the touch screen device 10. Thus, it is required to increase the capacity of a vibration unit to increase the vibrational force of the device. This increases the production cost of the touch screen device 10 and deteriorates the degree of freedom of installation space in the touch screen device 10.

Furthermore, as can be understood in [Equation 1], a vibrational force G is in to inverse proportion to a total mass M. That is, if the total mass M reduces, the vibrational force G increases. If a partial mass m which is the mass of a vibrating element increases or a vibrational displacement x of the vibrating element increases, the vibrational force G increases.

G=(−m·x·w²)/M [Equation 1]

Therefore, based on [Equation 1], a touch screen device which is constructed such that the vibrational force G thereof can be increased by controlling the total mass, the partial mass and the vibrational displacement of the touch screen device, and abrasion between elements thereof can be prevented is required.

### SUMMARY OF THE INVENTION

The present invention has been made in an effort to provide a touch screen device which can increase the vibrational force and prevent abrasion between elements.

In a touch screen device according to an embodiment of the present invention, a touch screen panel receives an external input signal. An image display is provided under the touch screen panel. The image display converts an electric signal into an image signal. A rigid body which vibrates is provided under the image display. A first connector connects the image display to the rigid body. A vibration unit is mounted to the rigid body to generate vibrations. A weight is mounted to the rigid body to increase a mass of the rigid body. An elastic member is mounted to the rigid body to increase a vibrational displacement of the rigid body. A lower support is provided under the rigid body. A second connector connects the rigid body to the lower support. A third connector connects the touch screen panel to the lower support.

The touch screen panel may be integrated with the image display.

The vibration unit may comprise a piezoelectric or polymer actuator or motor.

The weight may be made of material having a high density.

The elastic member may comprise a coil spring or a plate spring increasing the vibrational displacement of the rigid body when the rigid body vibrates in a vertical direction.

The elastic member may be integrally formed at a predetermined position in the rigid body.

Each of the first connector, the second connector and the third connector may comprises elastic material for absorbing external vibration and impact.

Furthermore, a vibration frequency of the rigid body may be changed depending on a shape of the elastic member.

In a touch screen device according to the present invention, a total mass of a part which is vibrated by a vibrating element is reduced. A partial mass that is the mass of a rigid body which vibrates using a vibration unit is increased. A vibrational displacement of the rigid body which vibrates along with the vibration unit is increased. Therefore, the vibrational force of the device can be maximized.

Furthermore, it is unnecessary to increase the size of the vibration unit which is made of expensive material, to increase the vibrational force. In other words, the present invention can reduce the size of the vibration unit, thus reducing the production cost of the touch screen device.

In addition, because the vibration unit is fastened to the rigid body, the vibration unit can be prevented from being damaged, for example, by falling. Thus, the strength of the touch screen device can be improved. As well, the modularization of the rigid body, the vibration unit and the first connector can be realized.

Moreover, the frequency of the rigid body can be changed depending on the shape of the elastic members or elastic portions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view illustrating a touch screen device, according to an embodiment of the present invention;

FIG. 2 is a view showing a weight and a vibration unit which are mounted to a rigid body of the touch screen device according to the present invention;

FIG. 3 is a view showing elastic members mounted to the rigid body of the touch screen device according to the present invention;

FIG. 4 is an enlarged view of the rigid body of the touch screen device according to the present invention;

FIG. 5 illustrates another embodiment of elastic members mounted to the touch screen device according to the present invention;

FIG. 6 is a side view of the rigid body according to the present invention;

FIG. 7 illustrates another embodiment of elastic members mounted to the touch screen device according to the present invention; and

FIG. 8 is a sectional perspective view of a touch screen device according to a conventional technique.

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, an embodiment of the present invention will be described in detail with reference to the attached drawings.

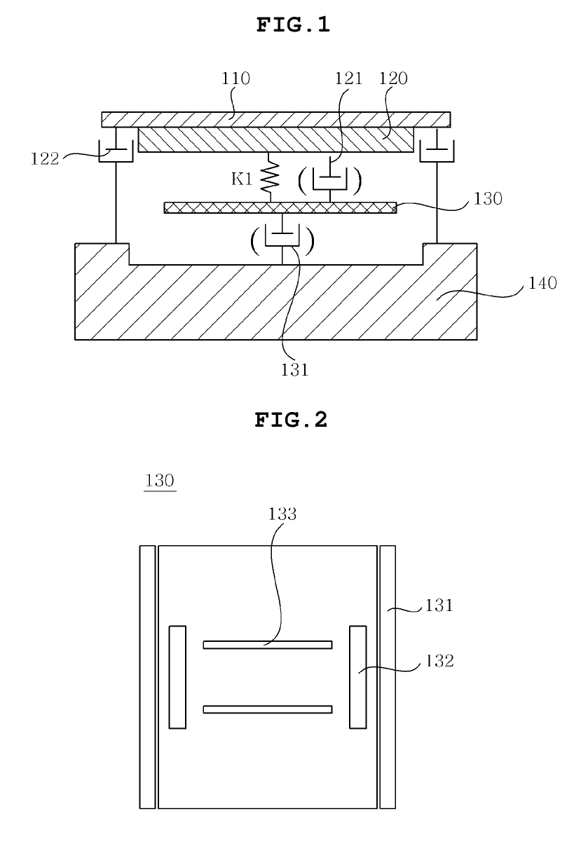

FIGS. 1 through 7 illustrate a touch screen device 100 according to the embodiment of the present invention. The touch screen device 100 includes a touch screen panel 110, an image display 120, a rigid body 130 and a lower support 140.

The touch screen device 110 according to the present invention is configured as to maximize the vibrational force. As illustrated in Equation 1 pertaining to the vibrational force, the vibrational force G of the touch screen device 100 can be increased by reducing a total mass M of the touch screen device 100, by increasing a partial mass m which is the mass of a vibrating element or by increasing a vibrational displacement x of the vibrating element.

G=(−m·x·w²)/M [Equation 1]

The present invention provides the structure of the touch screen device 100 which is adapted to the above-mentioned methods of increasing the vibrational force G.

As shown in FIG. 1, the touch screen device 100 according to the present invention includes the touch screen panel 110. The image display 120 is provided under the touch screen panel 110. The rigid body 130 is connected to the lower surface of the image display 120 through a first connector 121. The lower support 140 is connected to the lower surface of the rigid body 130 through second connectors 131.

The touch screen panel 110 is transparent and flexible and functions as a signal input surface which enables a user to observe an image displayed on the image display 120 and press it to input a signal. For instance, the touch screen panel 110 has a rectangular shape which extends a predetermined length in the longitudinal direction of the touch screen device 100.

Furthermore, the touch screen panel 110 is made, for example, by laminating an outer film, an ITO (indium tin oxide) film and a base film.

In detail, the outer film is disposed on a front surface of a mobile communication terminal and is sectioned into a viewing area within which touch input is available, and a dead space area which is formed around the viewing area. The outer film is made of transparent film material, such as PET (poly ethylene terephthalate), to allow the user to observe the image display 120 through the outer film.

The ITO film is formed by laminating two upper and lower film layers, although it is not in detail shown in the drawings. A dot spacer is interposed between the upper and lower film layers of the ITO film to maintain the distance therebetween constant. An electrode membrane having an X-axis pattern and a Y-axis pattern is provided on the perimeter of each film layer. The X-axis pattern and the Y-axis pattern are electrically separated from each other by an insulator (not shown). The electrode membrane is exposed outside the ITO film through an FPC (flexible printed circuit) cable and is electrically connected to the mobile communication terminal.

The base film supports the entire touch panel. For example, a glass substrate having superior transmissivity and a high touch response speed can be used as the base film.

The image display 120 is mounted under the touch screen panel 110. The image display 120 converts a variety of electrical information provided by various units into visual information using the variation of transmittance of a liquid crystal which depends on applied voltage. The image display 120 comprises one or more layers.

The touch screen panel 110 may be integrated with the image display 120.

The rigid body 130 which vibrates is mounted under the image display 120. The vibration units 132 which generate vibrations are provided on the rigid body 130. The installation location, the shape and the characteristics of each vibration unit 132 which is provided on the rigid body 130 will be explained in detail later with reference to FIG. 2.

The rigid body 130 is connected to the lower surface of the image display 120 through the first connector 121. The first connector 121 can systemically separate the touch screen panel 110 and the image display 120 from the rigid body 130. The first connector 121 may be removed depending on a systemic design of the device.

In the embodiment, the first connector 121 comprises a damper and intercepts vibration or impact caused by bending attributable to the application of external force. The damper may include a gel type damper made of solid or liquid. That is, the first connector 121 comprises the damper which is formed by applying liquid material and irradiating UV rays thereupon. Thus, the first connector 121 systemically divides the mass of the device.

The lower support 140 is connected to the lower surface of the rigid body 130 by the second connectors 131.

The lower support 140 comprises a circuit board or a casing. The second connectors 131 can systemically separate the rigid body 130 from the lower support 140. The second connectors 131 may be removed depending on the systemic design of the device.

In the embodiment, each second connector 131 comprises a damper and intercepts vibrations or impact caused by bending attributable to an external force being applied. The damper may include a gel type damper made of solid or liquid. In other words, the second connector 131 comprises the damper which is formed by applying liquid material and irradiating UV rays thereupon and thus systemically divides the mass of the device.

Furthermore, third connectors 122 connect the touch screen panel 110 to the lower support 140. The third connectors 122 can systemically separate the touch screen panel 110 from the lower support 140, and they may be removed depending on the systemic design of the device.

In the embodiment, each third connector 122 comprises a damper and intercepts vibrations or impact caused by bending attributable to an external force being applied. The damper may include a gel type damper made of solid or liquid. That is, the third connector 122 comprises the damper which is formed by applying liquid material and irradiating UV rays thereupon and thus systemically divides the mass of the device.

In the present invention, the vibration units 132 are provided on the rigid body 130 which is systemically separated from the lower support 140. Thus, vibrations generated from the vibration units 132 are prevented from being transmitted to the lower support 140 through the second connectors 131. Thereby, the total mass M of the part which is vibrated by the vibrating element is reduced.

Therefore, according to [Equation 1], the vibrational force G of the upper parts which are touched by the user can be increased by reducing the total mass M of the part which is vibrated by the vibrating element, thus maximizing a sensation of vibration transmitted to the user.

As shown in FIG. 2, the vibration units 132 which generate vibrations are provided on the rigid body 130.

Each vibration unit 132 comprises a piezoelectric (or polymer) actuator or motor which can be formed thin and generate vibrations in such a way that it is expanded and contracted by external power in the longitudinal direction.

The shape of the vibration unit 132 is not limited to a special shape and, generally, it has a bar shape. The installation location of the vibration unit 130 is also not limited and, generally, it is provided in the perimeter of the rigid body 130.

In the embodiment, the second connectors 131 are coupled to the edge of the rigid body 130 to systemically separate the rigid body 130 from the lower support 140. The vibration units 132 are fastened to the rigid body 130. Hence, the vibration units 132 are prevented from being damaged, for example, by falling, and the strength thereof is improved.

Furthermore, weights 133 are mounted to the rigid body 130 on which the vibration units 132 are provided, so that the mass of the rigid body 130 that vibrates along with the vibration units 132 is increased, thus maximizing the vibrational force G. In addition, vibrational force generated by mass eccentricity can be used (refer to Equation 1).

Each weight 133 is typically made of material having high density, for example, tungsten. The weight 133 can be located at any position on the rigid body. In other words, the installation location of the weight 133 is not restrained, for instance, it may be mounted to the central portion of the rigid body 130.

The second connectors 131 which are connected to the edge of the rigid body 130 space the rigid body 130 apart from the lower support 140 and function as shock absorbers for the lower support 140 when the rigid body 130 vibrates.

As such, in the touch screen device 110 according to the present invention, the weights 133 are mounted to the rigid body 130 so that the partial mass m which is the mass of the vibrating element is increased. Thereby, the vibrational force G can be increased.

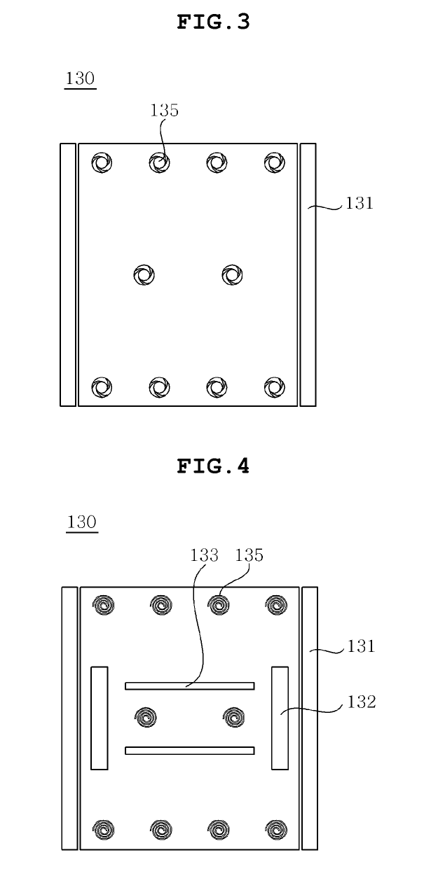

FIG. 3 illustrates elastic members 135 mounted to the rigid body 130. The elastic members 135 are provided on the perimeter and the central portion of the rigid body 130.

The elastic members 135 function to minimize abrasion of the rigid body 130 when operating in the vertical direction and to increase a vibrational displacement x to maximize the vibrational force G (refer to Equation 1).

The elastic members 135 can be disposed at any locations on the rigid body 130, in other words, the installation locations thereof are not restrained. In addition, each elastic member 135 can be made of any material, if it is of an appropriate elasticity which is capable of increasing the displacement thereof.

Here, particularly, the elastic members 135 which are provided on the central portion of the rigid body 130 prevent the vibration units 132 which move upwards and downwards when vibrating from coming into contact with other elements, thus preventing noise and abrasion of the vibration unit 132.

Furthermore, the frequency of the rigid body 130 may be changed depending on the shape of the elastic member 135. The shock absorption effect of the elastic member 135 when the vibration unit 132 vibrates can be further increased by attaching an additional liquid or solid damper to the elastic member 135.

In the embodiment, each elastic member 135 may comprise a coil spring or a plate spring.

FIG. 4 illustrates the second connectors 131, the vibration units 132, the weights 133, and the elastic members 135 which are mounted to the rigid body 130.

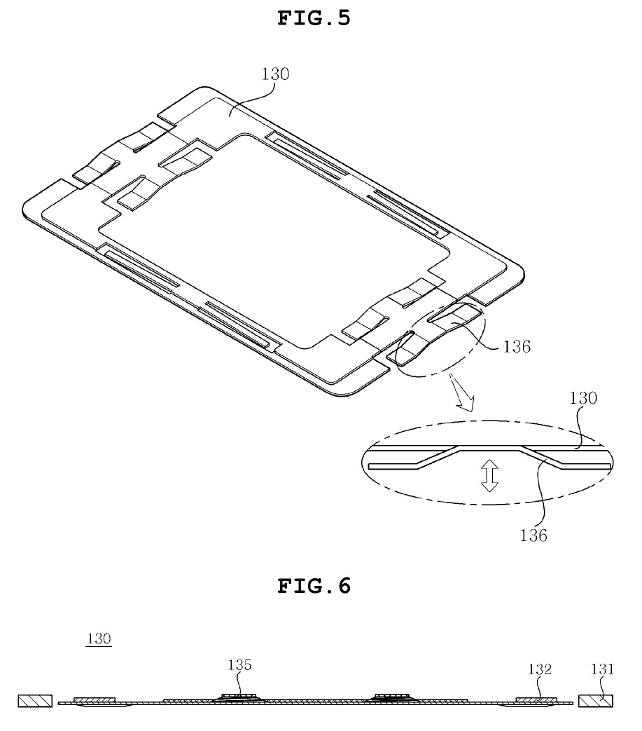

FIG. 5 illustrates plate type elastic members 136 provided on the rigid body 130. In this case, when the rigid body 130 vibrates upwards and downwards, the elastic members 136 are elastically operated in such a way that the plates are expanded and contracted in the longitudinal direction.

FIG. 6 is a side view of the structure in which the vibration units 132 and the elastic members 135 are mounted to the rigid body 130 and the second connectors 131 are to coupled to the edges of the rigid body 130.

The structure of FIG. 6 illustrates only one example, and the shapes and sizes of the vibration units 132 and the elastic members 135 are not restrained. The locations at which the vibration units 132 are mounted to the rigid body 130 are also not restrained.

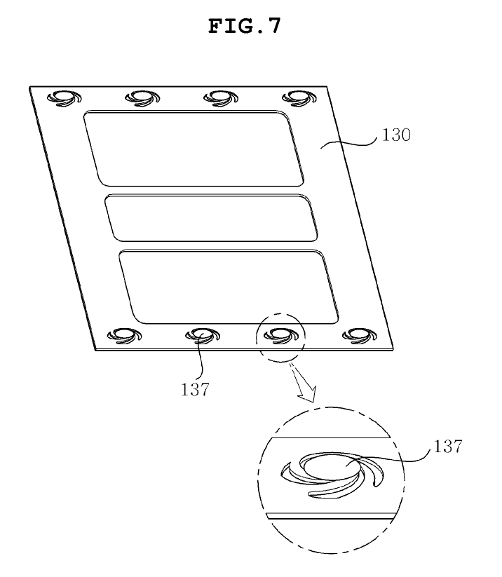

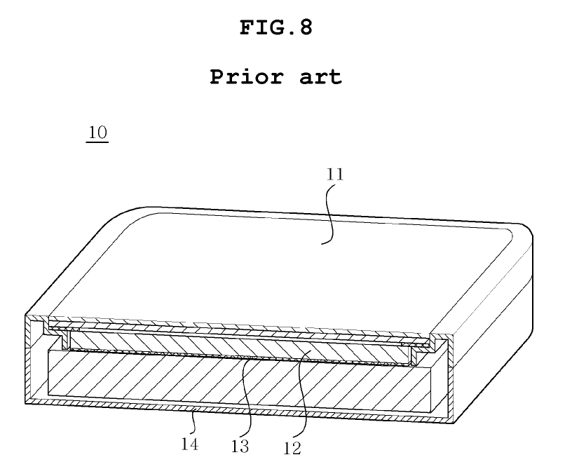

FIG. 7 illustrates the structure of a rigid body 130 which can provide elastic energy by itself. In this case, the strength of the rigid body 130 becomes superior. Because elastic portions 137 which function to increase a vibrational displacement x are integrally formed in the perimeter of the rigid body 130, the space in which the rigid body 130 can move is increased.

The touch screen device 100 according to the present invention reduces the total mass M of the part which is vibrated by the vibrating element, increases the partial mass m that is the mass of the rigid body 130 which vibrates using the vibration units 132, and increases the vibrational displacement x of the rigid body 130 which vibrates along with the vibration units 132. Therefore, the vibrational force of the device can be maximized.

Furthermore, it is unnecessary to increase the size of the vibration unit 132 which is made of expensive material, to increase the vibrational force. In other words, the present invention can reduce the size of the vibration unit 132, thus reducing the production cost of the touch screen device 100.

In addition, because the vibration units 132 are fastened to the rigid body 130, the vibration units 132 can be prevented from being damaged, for example, by falling. Thus, the strength of the touch screen device 100 can be improved. As well, the modularization of the rigid body 130, the vibration units 132 and the first connector 121 can be realized.

Moreover, the frequency of the rigid body 130 can be changed depending on the shape of the elastic members 135, 136 or the elastic portions 137.

Although the embodiments of the present invention have been disclosed for illustrative purposes, it will be appreciated that a touch screen device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen device, comprising:
a touch screen panel receiving an external input signal;
an image display provided under the touch screen panel, the image display converting an electric signal into an image signal;
a rigid body provided under the image display, the rigid body vibrating;
a first connector connecting the image display to the rigid body;
a vibration unit mounted to the rigid body to generate vibrations;
a weight mounted to the rigid body to increase a mass of the rigid body;
an elastic member mounted to the rigid body to increase a vibrational displacement of the rigid body;
a lower support provided under the rigid body;
a second connector connecting the rigid body to the lower support; and
a third connector connecting the touch screen panel to the lower support.

2. The touch screen device as set forth in claim 1, wherein the touch screen panel is integrated with the image display.

3. The touch screen device as set forth in claim 1, wherein the vibration unit comprises a piezoelectric or polymer actuator or motor.

4. The touch screen device as set forth in claim 1, wherein the weight is made of a material having a high density.

5. The touch screen device as set forth in claim 1, wherein the elastic member comprises a coil spring or a plate spring increasing the vibrational displacement of the rigid body when the rigid body vibrates in a vertical direction.

6. The touch screen device as set forth in claim 1, wherein the elastic member is integrally formed at a predetermined position in the rigid body.

7. The touch screen device as set forth in claim 1, wherein each of the first connector, the second connector and the third connector comprises elastic material for absorbing external vibration and impact.

8. The touch screen device as set forth in claim 1, wherein a vibration frequency of the rigid body is changed depending on a shape of the elastic member.
